(19) United States
(12) Patent Application Publication
(10) Pub. No.: US 2012/0046845 A1
(43) Pub. Date: Feb. 23, 2012

(54) METHOD FOR OPERATING A DIESEL ENGINE

(75) Inventor: Miguel Angel GIOVINGO, Turin (IT)

(73) Assignee: GM GLOBAL TECHNOLOGY OPERATIONS LLC., Detroit, MI (US)

(21) Appl. No.: 13/211,941

(22) Filed: Aug. 17, 2011

(30) Foreign Application Priority Data
Aug. 17, 2010 (GB) 1013744.6

(51) Int. Cl. G01M 15/10

(52) U.S. Cl. 701/99

(57) ABSTRACT

A method is provided for operating a Diesel engine that includes, but is not limited to measuring a value of an oxygen concentration in an exhaust gas flow discharged by the Diesel engine, determining a value of a parameter indicative of a fuel quantity that has been injected into the Diesel engine, on the basis of the measured value of the oxygen concentration, calculating a difference between the determined value of this parameter and a desired value of the parameter, and identifying a failure of a fuel injection apparatus of the Diesel engine if the calculated difference exceeds a positive threshold value of this difference.

### CROSS-REFERENCE TO RELATED APPLICATION

This application claims priority to British Patent Application No. 1013744.6, filed Aug. 17, 2010, which is incorporated herein by reference in its entirety.

### TECHNICAL FIELD

The technical field relates to a method for operating a Diesel engine, typically a Diesel engine of a motor vehicle.

### BACKGROUND

It is known that modern Diesel engines are provided with a fuel injection apparatus for direct injecting the fuel into the cylinders of the engine. The fuel injection apparatus generally comprises a fuel rail and a plurality of electrically controlled fuel injectors, which are individually located in a respective cylinder of the engine and which are hydraulically connected to the fuel rail through dedicated feeding conduits. As a matter of fact, each fuel injector generally comprises a nozzle and a movable needle which repeatedly opens and closes this nozzle, thereby injecting the fuel into the cylinder through a plurality of fuel injections.

The needle is moved by means of a dedicated actuator, typically a solenoidal actuator or a piezoelectric actuator, which is controlled by an engine control unit (ECU). As a matter of fact, the ECU operates each fuel injection by commanding the actuator to open the fuel injector nozzle and, after a certain time period, by commanding the actuator to close the fuel injector nozzle. The time period between the opening command and the closing command is generally referred as energizing time of the fuel injector, and it is determined by the ECU as a function of a desired quantity of fuel to be injected. During the engine life, the fuel injection apparatus is however subjected to a progressive deterioration, to the point that the quantity of fuel actually injected into the engine may widely differ from the desired one. This deterioration is mainly caused by the presence of carbon and metal deposits in the fuel and by fuel injectors wear.

In greater details, the carbon and metal deposits generally tend to accumulate into the injectors nozzle, thereby progressively clogging the nozzle hole and therefore leading to a reduced injected fuel quantity. On the contrary, the wear of the injectors, such as for example the wear of the injector needle and/or the wear of the needle seat, could cause the injection of an exceeding fuel quantity. In any case, a wide difference between the injected fuel quantity and the desired one increases the polluting emission of the Diesel engine and it also causes other important side effects.

By way of example, an exceeding injected fuel quantity increases the temperature inside the cylinder and the temperature of the exhaust gas, to the point that it could provoke engine damages and even a piston melting, which can lead to the piston seizure. From the other side, a reduced injected fuel quantity worsens the performance of the engine, to the point that it could even prevent the fuel combustion into the engine cylinders.

In view of the above, it is at least one object to provide a strategy for identifying if the fuel injection apparatus of a Diesel engine is too deteriorated, so as to be able to apply the necessary countermeasures. At least another object is to protect the Diesel engine against the damages which can occur if the injected fuel quantity is excessively different from the desired one. In addition, other objects, desirable features and characteristics will become apparent from the subsequent summary and detailed description, and the appended claims, taken in conjunction with the accompanying drawings and this background.

### SUMMARY

An embodiment of the invention provides a method for operating a Diesel engine comprising the steps of: measuring a value of an oxygen concentration in an exhaust gas flow discharged by the Diesel engine, determining a value of a parameter indicative of a fuel quantity injected into the Diesel engine, on the basis of the measured value of the oxygen concentration, calculating a difference between the determined value of this parameter and a desired value of the parameter (namely an algebraic difference, which can be either positive or negative), and identifying a failure of a fuel injection apparatus of the Diesel engine if the calculated difference exceeds a positive threshold value of this difference.

Provided that the positive threshold value is properly calibrated, this strategy is advantageously able to identify if the fuel injection apparatus is excessively deteriorated, thereby allowing to perform any appropriate procedures for preventing engine damages and/or for signaling to the user that a maintenance of the fuel injection apparatus is urgently required. According to this embodiment of the invention, the above mentioned parameter indicative of the injected fuel quantity can be the injected fuel quantity itself or, alternatively, any parameter related to this quantity, such as for example the air to fuel ratio of the mixture that is fed into the engine. Furthermore, the above mentioned difference between the determined value of the parameter and the related desired value can be calculated as the determined value minus the desired value or, alternatively, as the desired value minus the determined value. As a matter of fact, all these alternatives allow to identify an excessive deterioration of the fuel injection system.

According to another embodiment of the invention, the positive threshold value is empirically determined In this way, the positive threshold value can be determined during a single experimental activity performed on a specific Diesel engine, and then it can be advantageously used for performing the present strategy on any motor vehicle equipped with that kind of Diesel engine.

According to an embodiment of the invention, the method provides for identifying the failure of the fuel injection apparatus also if the calculated difference, between the determined value of the parameter and the desired value of the parameter, falls below a negative threshold value of this difference. Thanks to this embodiment, the present strategy is advantageously able to identify if the fuel injection apparatus is excessively deteriorated, both when this deterioration increases the injected fuel quantity and when this deterioration reduces the injected fuel quantity with respect to the desired one. According to this embodiment, the negative threshold value can be empirically determined, thereby achieving the same advantages previously explained for the positive threshold value.

According to another embodiment of the invention, the parameter involved in the present method is indicative of a fuel quantity injected into a single cylinder of the Diesel engine. This embodiment of the invention has the advantage of allowing the present strategy to identify if a specific injector of the Diesel engine is excessively deteriorated. According to this embodiment, the determination of the value of the parameter provides for: measuring the value of the oxygen concentration in an exhaust gas flow discharged by the single cylinder, and determining the value of the parameter on the basis of this value of the oxygen concentration. This has the advantage of allowing a simple and very reliable determination of the actual value of the parameter for the single cylinder. Accordingly, the oxygen concentration in the exhaust gas flow discharged by the single cylinder can be measured by acquiring a value of the oxygen concentration, which is measured in a portion of an exhaust line of the Diesel engine, typically a portion located between a discharge manifold and a turbine of a turbocharger, while the above mentioned exhaust gas flow passes through this portion. In this way, this measurement can be advantageously performed for any cylinder of Diesel engine using only one fast response oxygen sensor, typically a Universal Exhaust Gas Oxygen (UEGO) sensor, which is located in that portion of the exhaust line.

According to another embodiment, the steps of determining the value of the parameter, of calculating the difference between the determined value and the desired value of this parameter, and of identifying the failure, are performed for every cylinder of the Diesel engine. In this way, the present strategy is able to identify a malfunction of the injector of each cylinder of the Diesel engine.

According to still another embodiment of the invention, the method comprises the further step of performing an emergency procedure if the failure the fuel injection apparatus of the Diesel engine is identified. Thanks to this embodiment, the emergency procedure can comprise all the necessary countermeasures necessary to prevent Diesel engine damages. By way of example, the emergency procedure can comprise the step of generating an alert signal informing the user of the malfunction of the fuel injection apparatus and/or the step of automatically shutting off the Diesel engine.

The method according to any embodiment of the invention can be carried out with the help of a computer program comprising a program-code for carrying out all the steps of the method described above, and in the form of a computer program product comprising the computer program. The computer program product can be embodied as a Diesel engine comprising an engine control unit (ECU), a data carrier associated to the ECU, and the computer program stored in the data carrier, so that, when the ECU executes the computer program, all the steps of the method described above are carried out.

The method can be embodied as an electromagnetic signal, said signal being modulated to carry a sequence of data bits which represent a computer program to carry out all steps of the method.

### BRIEF DESCRIPTION OF THE DRAWINGS

The present invention will hereinafter be described in conjunction with the following drawing figures, wherein like numerals denote like elements, and:

FIG. 1 is a schematic representation of a Diesel engine; and

FIG. 2 is a flowchart of an operating method according to an embodiment of the invention.

### DETAILED DESCRIPTION

The following detailed description is merely exemplary in nature and is not intended to limit application and uses. Furthermore, there is no intention to be bound by any theory presented in the preceding background or summary or the following detailed description.

An embodiment of the invention is hereinafter described with reference to a Diesel engine 10 of a motor vehicle. The Diesel engine 10 schematically comprises: a plurality of cylinders 11, each of which accommodates a reciprocating piston; an intake manifold 12 connected to all the cylinders 11 and to an intake line 13, for feeding fresh air from the environment into each cylinder 11; and an exhaust manifold 14 connected to all the cylinders 11 and to an exhaust line 15, for discharging the exhaust gas from each cylinder 11 into the environment.

In the present embodiment, the Diesel engine 10 is further equipped with a turbocharger 20 comprising a compressor 21 located in the intake line 13, and a turbine 22 located in the exhaust line 15 and provided for driving said compressor 21. The Diesel engines 10 is also equipped with a fuel injection apparatus 30 for direct injecting fuel into the cylinders 11, which comprises a fuel rail 31 and a plurality of electrically controlled fuel injectors 32, which are individually associated to a respective cylinder 11 and which are hydraulically connected to the fuel rail 31 through dedicated feeding conduits 33. As a matter of fact, each fuel injector 32 generally comprises a nozzle, a needle and an actuator, typically a solenoidal actuator or a piezoelectric actuator, which moves the needle in order to repeatedly open and close the nozzle, thereby injecting the fuel into the respective cylinder 11 through a plurality of separated fuel injections.

The nozzle, the needle and the actuator are not described in details since they are of conventional kind. The actuator of each fuel injector 32 is controlled by an engine control unit (ECU) 40, which operates each fuel injection by commanding the actuator to open the fuel injector nozzle and, after a certain time period, by commanding the actuator to close the fuel injector nozzle.

The time period between the opening command and the closing command is generally referred as energizing time of the fuel injector 32, and it is determined by the ECU 40 as a function of a desired quantity of fuel to be injected. The desired value of the injected fuel quantity is determined by the ECU 40, generally by means of an empirically determined map which correlates the desired value of the injected fuel quantity to a plurality of engine operating parameters, such as for example the engine speed and the engine torque.

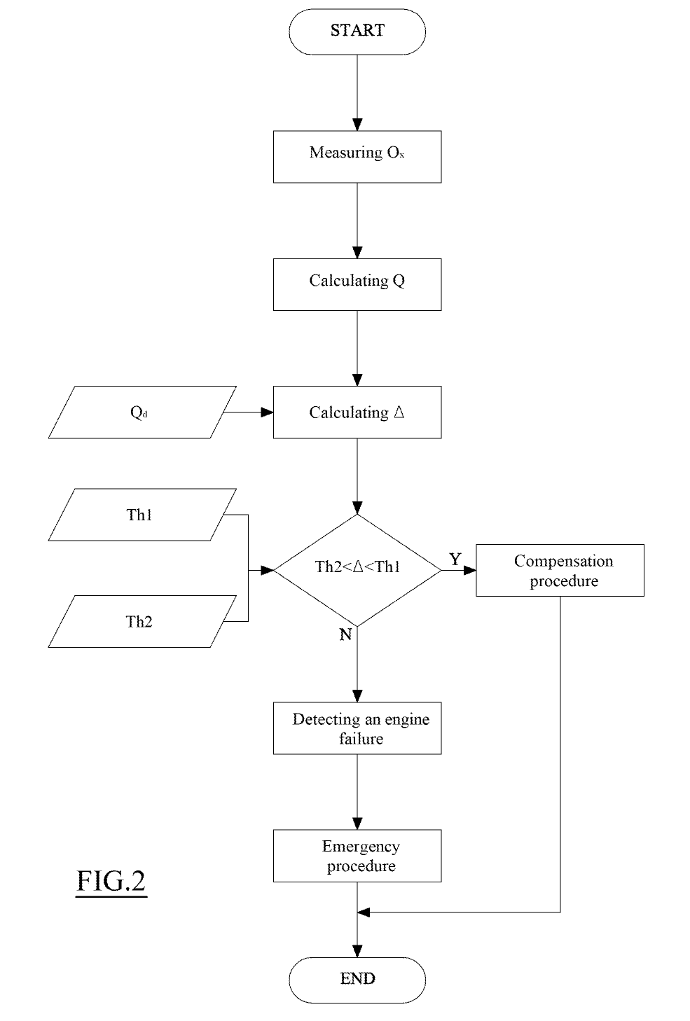

The present embodiment of the invention provides a method for operating the Diesel engine 10, which allows to identify a failure of the fuel injection apparatus 30. The steps of the method described hereinafter are performed by the ECU 40. As shown in FIG. 2, the method provides for measuring a value Ox of an oxygen concentration in an exhaust gas flow, wherein this exhaust gas flow is discharged by a single cylinder 11 during one of its engine cycles, namely during the discharge phase of this engine cycle.

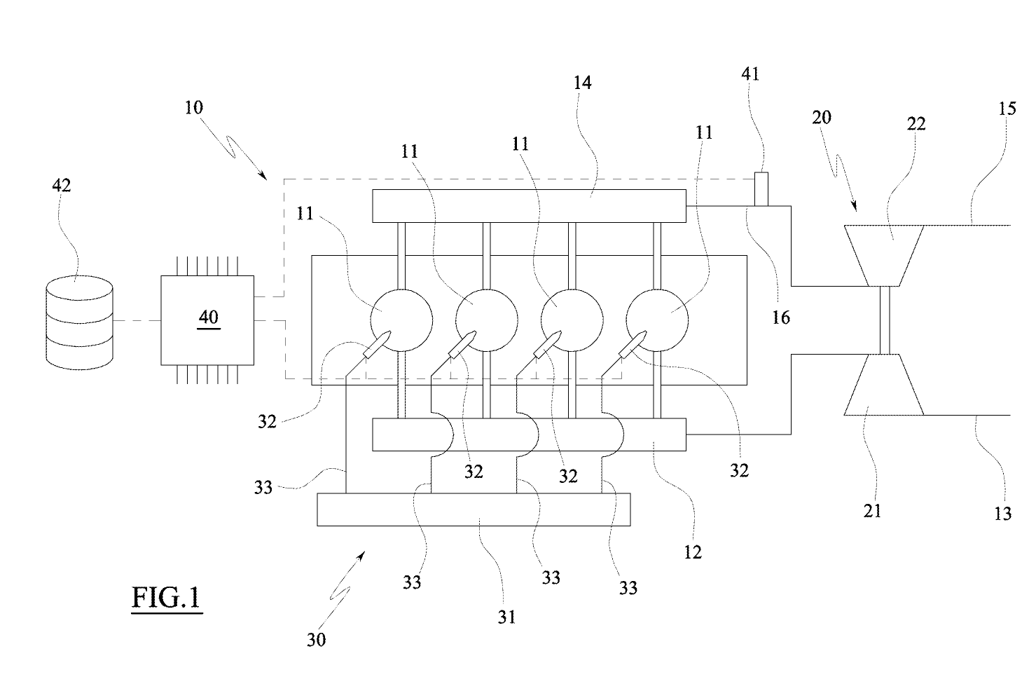

This measurement is performed by means of a fast response UEGO sensor 41 (see FIG. 1), which is connected to the ECU 40 and which is located in a portion 16 of the exhaust line 15 comprised between the exhaust manifold 14 and the turbine 22. The value Ox of the oxygen concentration is the value sensed by the UEGO sensor 41, while the above mentioned exhaust gas flow passes through said portion 16 of the exhaust line 15. As a matter of fact, this value Ox can be identified by plotting the values sensed by the UEGO sensor 41 in a time-line, and by comparing this plot with the timing of the engine cycles performed by the single cylinder 11. The measured value Ox is then used for calculating a value Q of the air to fuel ratio (AFR) of the mixture that has been fed into the single cylinder 11 during the engine cycle concerned, namely the engine cycle responsible of the above mentioned exhaust gas flow. The function correlating the oxygen concentration to the air to fuel ratio is known.

At this point, the method provides for calculating a difference Δ between the calculated value Q and a desired value Qd of the air to fuel ratio for that engine cycle. The desired value Qd can be determined by means of an empirically determined map correlating the desired values of the air to fuel ratio to the engine speed and to the desired value of the injected fuel quantity during that engine cycle.

In the present embodiment, the difference Δ is calculated according to the following equation:

Δ=Q−Q_{d}.

In this way, the difference Δ is positive if the quantity of fuel actually injected into the single cylinder 11 is smaller than the desired one, while the difference Δ is negative is negative if the quantity of fuel actually injected into the single cylinder 11 is bigger than the desired one. The calculated difference Δ is then compared with a positive threshold value Th1 and with a negative threshold value Th2 of this difference.

These positive and negative threshold values Th1 and Th2 are empirically determined during an experimental activity performed on a test Diesel engine having the same characteristics of the Diesel engine 10. In particular, the threshold values Th1 and Th2 are calibrated in order to represent respectively the maximum and the minimum of a range of values, outside of which the fuel injector 32 associated to the single cylinder 11 is considered too deteriorated, to the point that its operation can be harmful for the Diesel engine 10.

In greater details, the positive threshold value Th1 of the present embodiment of the invention represents a limit over which the fuel quantity actually injected is so small that the combustion into the single cylinder 11 is completely ineffective. This event can occur for example if the fuel injector 32 is completely clogged.

The negative threshold value Th2 of the present embodiment of the invention represents a limit below which the fuel quantity actually injected is so big that it can cause engine damages, such as for example a piston melting, which can lead to the piston seizure. This event can be due for example to an excessive wear of the injector needle and/or an excessive wear of the needle seat.

In view of the above, the method provides for identifying a failure of the fuel injection apparatus 30 if the calculated difference Δ exceeds the positive threshold value Th1 or if the calculated difference Δ falls below the negative threshold value Th2. If this failure of the Diesel engine 10 is identified, the method provides for performing an emergency procedure, which can comprise all the necessary countermeasures necessary to prevent Diesel engine damages. By way of example, the emergency procedure can comprise the step of generating an alert signal informing the user of the malfunction of the fuel injection apparatus 30 and/or the step of automatically shutting off the Diesel engine 10.

On the contrary, if the calculated difference Δ is comprised in the range of values between Th1 and Th2, the fuel injector 32 associated to the single cylinder 11 is considered enough efficient. In this case, the method can nevertheless provides for performing a compensation procedure, which generally corrects the injected fuel quantity for the single cylinder 11 so as to minimize the difference Δ in the next engine cycle. By way of example, this procedure can comprise the steps of using the calculated value Q to determine the quantity of fuel actually injected into the single cylinder 11, of calculating a difference between this injected fuel quantity and the desired one (determined as explained before), and of using this difference to correct the desired quantity of fuel to be injected into the single cylinder 11 during the next engine cycle, so as to correspondingly correct the injector energizing time.

According to the present embodiment of the invention, the steps of the method described above are repeated cycle by cycle for the single cylinder 11, and they are also performed for every cylinder 11 of the Diesel engine 10. Accordingly, the method can be performed with the help of a computer program comprising a program-code for carrying out all the steps of the method, which is stored in a data carrier 42 associated to the ECU 40. In this way, when the ECU 40 executes the computer program, all the steps of the methods described above are carried out.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the forgoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and in their legal equivalents.

What is claimed is:

1. A method for operating a Diesel engine comprising:
measuring a value of an oxygen concentration in an exhaust gas flow discharged by the Diesel engine;
determining a value of a parameter indicative of a fuel quantity injected into the Diesel engine, on at least a basis of the value of the oxygen concentration;
calculating a difference between the value of the parameter and a desired value of the parameter; and
identifying a failure of a fuel injection apparatus of the Diesel engine if the difference exceeds a positive threshold value of the difference.

2. The method according to claim 1, further comprising empirically determining the positive threshold value.

3. The method according to claim 1, wherein the failure of the fuel injection apparatus is identified also if the difference falls below a negative threshold value of the difference.

4. The method according to claim 3, further comprising empirically determining the negative threshold value.

5. The method according to claim 1, wherein the parameter is indicative of the fuel quantity injected into a single cylinder of the Diesel engine.

6. The method according to claim 5, wherein the determining of the value of the parameter comprises:
measuring the value of the oxygen concentration in the exhaust gas flow discharged by said single cylinder; and
determining the value of the parameter on the basis of this value of the oxygen concentration.

7. The method according to claim 6, wherein the measuring of the value of the oxygen concentration in the exhaust gas flow discharged by said single cylinder comprises acquiring a value of the oxygen concentration, which is measured in a portion of an exhaust line of the Diesel engine while said exhaust gas flow passes through the portion.

8. The method according to claim 5, wherein determining the value of the parameter, the calculating the difference between the value and the desired value of the parameter, and the identifying the failure, are performed for every cylinder of the Diesel engine.

9. The method according to claim 5, further comprising performing an emergency procedure if the failure of the fuel injection apparatus of the Diesel engine is identified.

10. The method according to claim 9, wherein the emergency procedure comprises generating an alert signal.

11. The method according to claim 9, wherein the emergency procedure comprises shutting off the Diesel engine.

12. A computer readable medium embodying a computer program product, said computer program product comprising:
a program for operating a Diesel engine, the program configured to:
measure a value of an oxygen concentration in an exhaust gas flow discharged by the Diesel engine;
determine a value of a parameter indicative of a fuel quantity injected into the Diesel engine, on at least a basis of the value of the oxygen concentration;
calculate a difference between the value of the parameter and a desired value of the parameter; and
identify a failure of a fuel injection apparatus of the Diesel engine if the difference exceeds a positive threshold value of the difference.

13. The computer readable medium embodying the computer program product according to claim 12, the program further configured to utilize an empirically determined threshold as the positive threshold value.

14. The computer readable medium embodying the computer program product according to claim 12, wherein the failure of the fuel injection apparatus is identified also if the difference falls below a negative threshold value of the difference.

15. The computer readable medium embodying the computer program product according to claim 14, the program further configured to utilize an empirically determined threshold as the negative threshold value.

16. The computer readable medium embodying the computer program product according to claim 12, wherein the parameter is indicative of the fuel quantity injected into a single cylinder of the Diesel engine.

17. The computer readable medium embodying the computer program product according to claim 16, wherein the program is configured to determine the value of the parameter by:
measuring the value of the oxygen concentration in the exhaust gas flow discharged by said single cylinder; and
determining the value of the parameter on the basis of this value of the oxygen concentration.

18. The computer readable medium embodying the computer program product according to claim 17, wherein the measuring of the value of the oxygen concentration in the exhaust gas flow discharged by said single cylinder comprises acquiring a value of the oxygen concentration, which is measured in a portion of an exhaust line of the Diesel engine while said exhaust gas flow passes through the portion.

19. The computer readable medium embodying the computer program product according to claim 17, wherein the program is configured to determine the value of the parameter, calculate the difference between the value and the desired value of the parameter, and identify the failure for every cylinder of the Diesel engine.

20. The computer readable medium embodying the computer program product according to claim 17, the program is further configured to performing an emergency procedure if the failure of the fuel injection apparatus of the Diesel engine is identified.
